(19) United States
(12) Patent Application Publication
(10) Pub. No.: US 2025/0349017 A1
(43) Pub. Date: Nov. 13, 2025

(54) METHODS AND APPARATUS FOR ESTIMATING DEPTH INFORMATION FROM THERMAL IMAGES

(71) Applicant: Rivet Industries, Inc., Washington, DC (US)

(72) Inventors: Seyedsohrab MADANI, Menlo Park, CA (US); Calin CRISTIAN, Iasi (RO); Jouya JADIDIAN, Los Gatos, CA (US); Mohit NARANG, Cupertino, CA (US)

(21) Appl. No.: 19/178,636

(22) Filed: Apr. 14, 2025

Related U.S. Application Data
(60) Provisional application No. 63/646,450, filed on May 13, 2024.

(51) Int. Cl. G06T 7/507; G06T 7/55; H04N 23/11

(52) U.S. Cl. CPC G06T 7/50; G06N 3/0455; G06N 3/088; G06T 2207/10024; G06T 2207/10048; G06T 2207/20084

(57) ABSTRACT

An apparatus can include an image encoder configured to be trained by a plurality of visible images captured by a visible light camera. The image encoder can be configured to output image encoder output. The apparatus can further include a text encoder configured to be trained by a plurality of text phrases. Each text phrase from the plurality of text phrases can be associated with an object with each visible image from the plurality of visible images. The text encoder can be configured to output text encoder output. The apparatus can further include a thermal encoder configured to be trained by a plurality of thermal images captured by a thermal camera. The thermal encoder can be configured to output thermal encoder output, the image encoder output, the text encoder output and the thermal encoder output collectively defining a shared latent space.

### CROSS REFERENCE TO RELATED APPLICATION

This application claims priority to U.S. Provisional Patent Application No. 63/646,450, filed May 13, 2024, and titled “METHODS AND APPARATUS FOR ESTIMATING DEPTH INFORMATION FROM THERMAL IMAGES,” the contents of which are incorporated by reference herein in its entirety.

### FIELD

The present disclosure generally relates to imaging, and more specifically to methods and apparatus for estimating depth information from thermal images.

### BACKGROUND

Thermal cameras are typically a very resilient modality for night vision but the images they produce lack features and depth cues for the human brain to perceive the physical environment effectively and efficiently. Known attempts at creating depth perception from two thermal sensors have failed particularly for relatively long ranges. Depth cameras cannot assist in dark scenes because their illuminators interfere with the thermal signal. Such depth cameras also typically do not operate effectively in bad weather and at relatively long ranges.

Thus, a need exists to obtain accurate depth values for thermal imagers (e.g., a monocular thermal camera), for example, with limited compute resources.

### SUMMARY

In an embodiment, an apparatus can include an image encoder configured to be trained by a plurality of visible images captured by a visible light camera. The image encoder can be configured to output image encoder output. The apparatus can further include a text encoder configured to be trained by a plurality of text phrases. Each text phrase from the plurality of text phrases can be associated with an object with each visible image from the plurality of visible images. The text encoder can be configured to output text encoder output. The apparatus can further include a thermal encoder configured to be trained by a plurality of thermal images captured by a thermal camera. The thermal encoder can be configured to output thermal encoder output, the image encoder output, the text encoder output and the thermal encoder output collectively defining a shared latent space.

In an embodiment, an apparatus can include a processor and a memory coupled to the processor. The memory can be configured to store an image encoder, a text encoder and a thermal encoder each having been trained to collectively define a shared latent space. The memory can further be configured to store an image decoder, a text decoder and a thermal decoder each having been trained based on the shared latent space. The image encoder can be configured to receive an input visible image and output to the shared latent space that is accessed by the text decoder to generate an output text phrase associated with the input visible image or accessed by the thermal decoder to generate an output thermal image associated with the input visible image. The text encoder can be configured to receive an input text phrase and output to the shared latent space that is accessed by the image encoder to generate an output visible image associated with the input text phrase or accessed by the thermal decoder to generate an output thermal image associated with the input text phrase. The thermal encoder can be configured to receive an input thermal image and output to the shared latent space that is accessed by the image encoder to generate an output visible image associated with the input thermal image or accessed by the text decoder to generate an output text phrase associated with the input thermal image.

In an embodiment, an apparatus can include a processor and a memory coupled to the processor. The memory can be configured to store a machine learning model having a thermal encoder, an image encoder, a thermal decoder and an image decoder. The memory can further store a depth extractor. The thermal encoder can be configured to receive an input thermal image and output an encoded thermal image to a shared latent space. The image decoder can be configured to generate an output visible image associated with the input thermal image based on the shared latent space. The depth extractor can be configured to receive the output visible image from the image decoder and to output first depth information associated with the input thermal image. The machine learning model can be configured to be retrained based on difference between the first depth information and second depth information associated with the encoded thermal image.

### BRIEF DESCRIPTION OF THE DRAWINGS

FIG. 1A is a block diagram of a system for decoding input files from thermal camera(s), visible light camera(s), and/or other input/output devices, according to an embodiment.

FIG. 1B is a block diagram of a compute device of FIG. 1B including a processor and a memory, according to an embodiment.

FIG. 2 is a block diagram illustrating training phases of the ML model(s) of FIGS. 1A and 1B, according to an embodiment.

FIG. 3 is a block diagram illustrating an example inference phase of the ML model(s) of FIGS. 1A and 1B, according to an embodiment.

FIG. 4 is a block diagram illustrating an example fine tuning process of the ML model(s) of FIGS. 1A and 1B, according to an embodiment.

FIG. 5A is a block diagram illustrating a depth estimation process of the ML model(s) of FIGS. 1A and 1B, according to an embodiment.

FIG. 5B illustrates an example input thermal image and example depth information associated with the block diagram of FIG. 5A, according to an embodiment.

FIG. 5C illustrates an example input thermal image, an example output visible image, and example depth information associated with the block diagram of FIG. 5A, according to an embodiment.

FIG. 6 illustrates a flowchart of a method associated with a training phase of the ML model(s) described herein, according to an embodiment.

FIG. 7 illustrates a flowchart of a method associated with an inference phase of the ML model(s) described herein, according to an embodiment.

FIG. 8 illustrates a flowchart of a method associated with a depth estimation process of the ML model(s) described herein, according to an embodiment.

### DETAILED DESCRIPTION

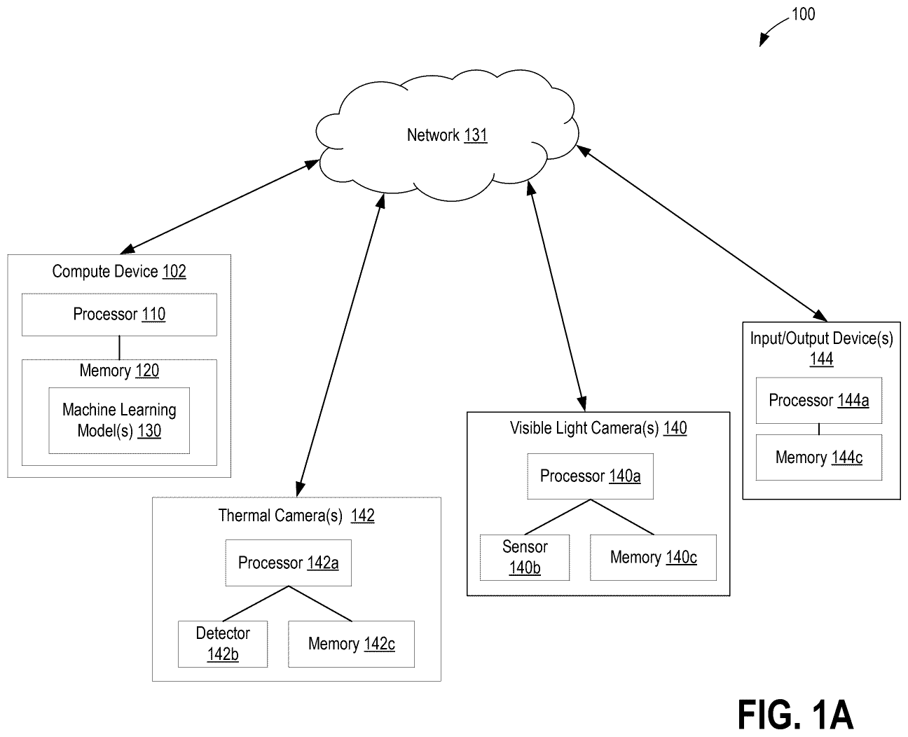

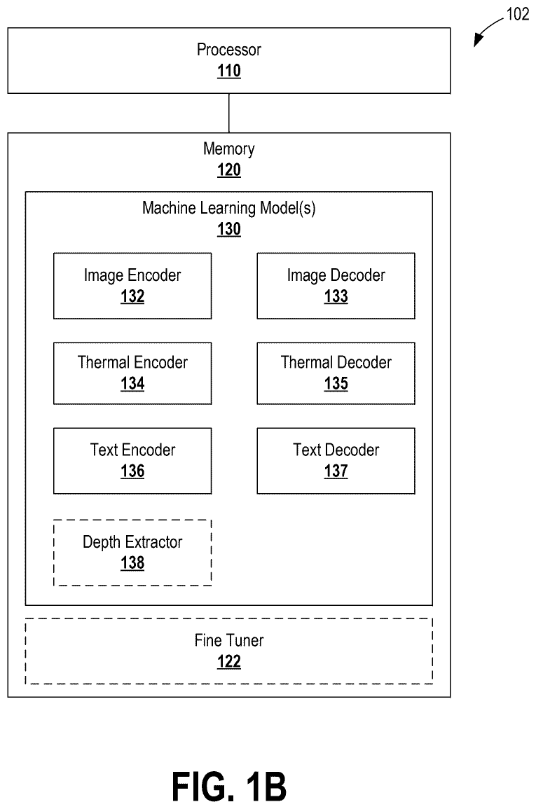

FIG. 1A is a block diagram of a system 100 for decoding input files from thermal camera(s) 142, visible light camera(s) 140, and/or other input/output (I/O) devices 144, according to an embodiment. The system 100 includes a compute device 102, the thermal camera(s) 142, the visible light camera(s) 140, the I/O devices 144, and a network 131. The compute device 102, the thermal camera(s) 142, the visible light camera(s) 140, and the I/O devices 144 are communicatively coupled via the network 131.

The thermal camera 142 can be, for example, a device that produces images using infrared (IR) radiation. The thermal camera 142 can also be referred to as a thermographic camera, thermal imager, thermal imaging camera, and IR camera. The thermal camera 142 can be, for example, a monocular thermal camera. The thermal camera 142 can include a processor 142a, a detector 142b, a memory 142c, and a communications interface (not shown). The processor 142a can be coupled to the memory 142c, the detector 142b, and the communication interface. The processor 142a (e.g., a central processing unit (CPU), a graphics processing unit (GPU), and/or the like) can be, for example, a hardware-based integrated circuit (IC) or any other suitable processing device configured to run or execute a set of instructions or codes. The memory 142c (e.g., a random-access memory (RAM), a hard drive, a flash drive, and/or the like) of the thermal camera 142 can store data, and/or code that includes instructions to cause the processor 142a to perform one or more processes or functions. The detector 142b can be, for example, cooled detectors or uncooled detectors. The communications interface (e.g., a network interface card (NIC), a Wi-Fi® transceiver, a Bluetooth® transceiver, and/or the like) can be a hardware component that facilitates data communication between the thermal camera 142 and other devices (e.g., the compute device 102, the visible light camera 140, the I/O devices 144, other compute devices coupled to the network 131 but not shown in FIG. 1, and/or the like).

The visible light camera 140 can be, for example, a device that produces images using sensors. The visible light camera 140 can be a low light camera. The visible light camera 140 can include a processor 140a, a sensor 140b, a memory 140c, and a communication interface (not shown). The processor 140a can be structurally and/or functionally similar to the processor 142a. The memory 140c can be structurally and/or functionally similar to the memory 142c. The sensors 140b can be single-photon avalanche sensors, complementary metal-oxide semiconductor (CMOS) sensors, etc. The communications interface of the visible light camera 140 can be structurally and/or functionally similar to the communications interface of the thermal camera 142. For example, the communications interface of the visible light camera 140 can facilitate data communication between the visible light camera 140 and other devices (e.g., the compute device 102, the thermal camera 142, the I/O devices 144, other compute devices coupled to the network 131 but not shown in FIG. 1, and/or the like).

The I/O devices 144 can be, for example, devices and/or components that are configured to receive inputs from and send outputs to other devices and/or a user operating other devices. For example, the I/O devices 144 can include at least one of a keyboard, a mouse, a trackpad, a microphone, etc. In some embodiments, the I/O devices 144 can include a processor 144a structurally and/or functionally similar to the processor 142a and/or the processor 140a. Further, the I/O devices 144 can include a memory 144c structurally and/or functionally similar to the memory 142c and/or the memory 140c. Further, the I/O devices 144 can include a communications interface (not shown) that is structurally and/or functionally similar to the communications interface of the thermal camera 142 and/or the communications interface of the visible light camera 140. For example, the communications interface of the I/O devices 144 can facilitate data communication between the I/O devices 144 and other devices (e.g., the compute device 102, the thermal camera 142, the visible light camera 140, other compute devices coupled to the network 131 but not shown in FIG. 1, and/or the like).

The compute device 102 can include, for example, a processor 110, a memory 120, and a communications interface (not shown). The processor 110 can be structurally and/or functionally similar to the processor 142a, the processor 140a, and/or the processor 144a. The memory 120 can be structurally and/or functionally similar to the memory 142c, the memory 140c, and/or the memory 144c. However, the memory 120 can include machine learning (ML) model(s) 130. The processor 110 can execute the ML models 130 to perform one or more processes or functions of the ML models 130. The ML models 130 can be, for example, transformer-based foundation models with multiple encoders and multiple decoders, as described in detail in connection with at least FIG. 1B.

The network 131 can be any suitable communications network for transferring data, operating over public and/or private communications networks. For example, the network 131 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the network 131 can be a wireless network such as, for example, a Wi-Fi or wireless local area network (“WLAN”), a wireless wide area network (“WWAN”), and/or a cellular network. In other instances, the network 131 can be a wired network such as, for example, an Ethernet network, a digital subscription line (“DSL”) network, a broadband network, and/or a fiber-optic network. The communications sent via the network 131 can be encrypted or unencrypted. In some instances, the network 131 can include multiple networks or subnetworks operatively coupled to one another by, for example, network bridges, routers, switches, gateways and/or the like. In some embodiments, the communications network is not needed and instead the thermal camera 142 and the compute device 102 can be direct connected for example by wired connection or a wireless connection.

FIG. 1B is a block diagram of the compute device 102 of FIG. 1B including the processor 110 and the memory 120, according to an embodiment. As previously mentioned, the memory 120 can include the ML models 130. Optionally, the memory 120 includes a fine tuner 122. The ML models 130 can include an image encoder 132, an image decoder 133, a thermal encoder 134, a thermal decoder 135, a text encoder 136, and a text decoder 137. Optionally, the ML models 130 can include a depth extractor 138.

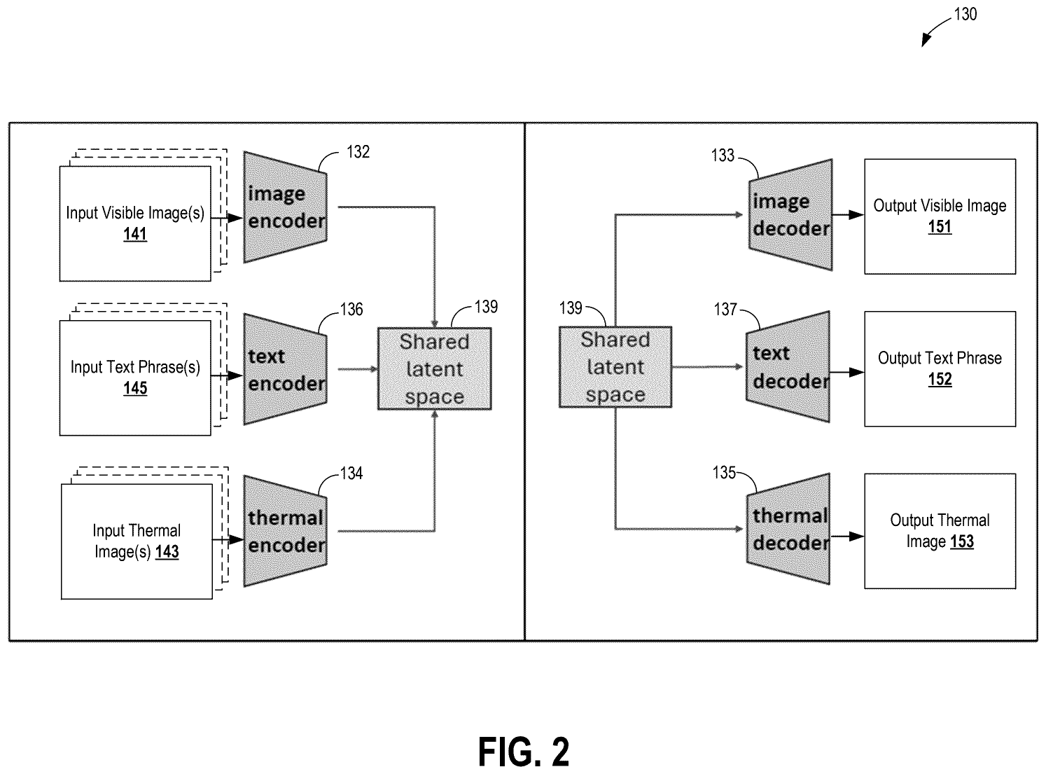

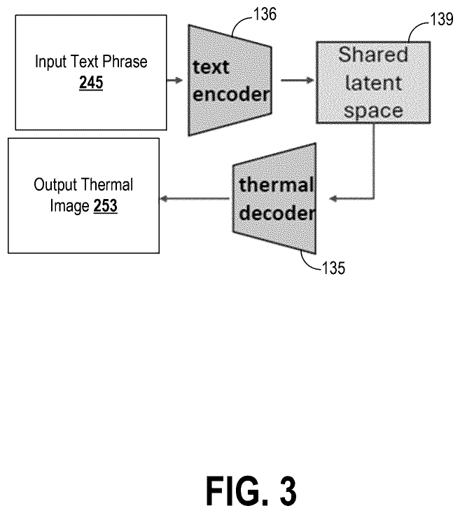

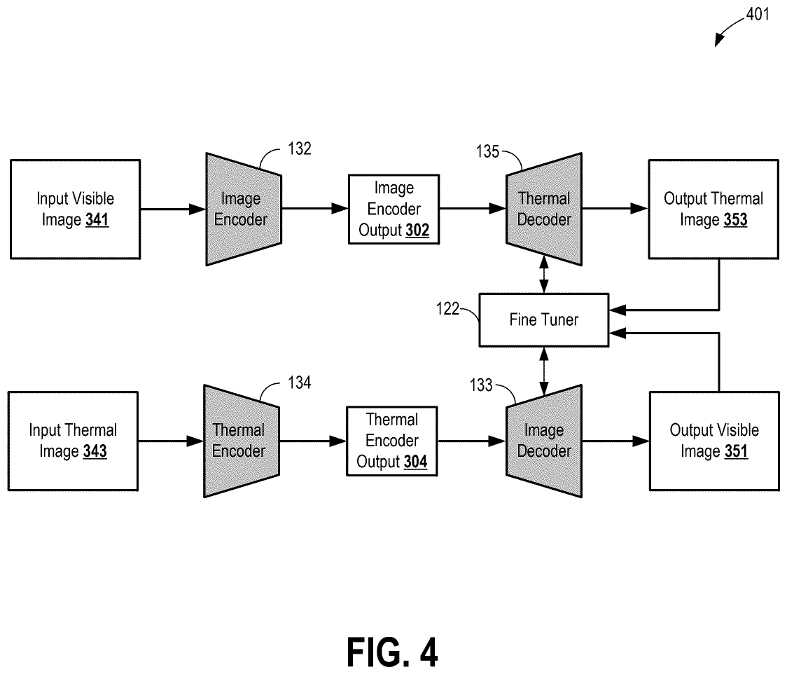

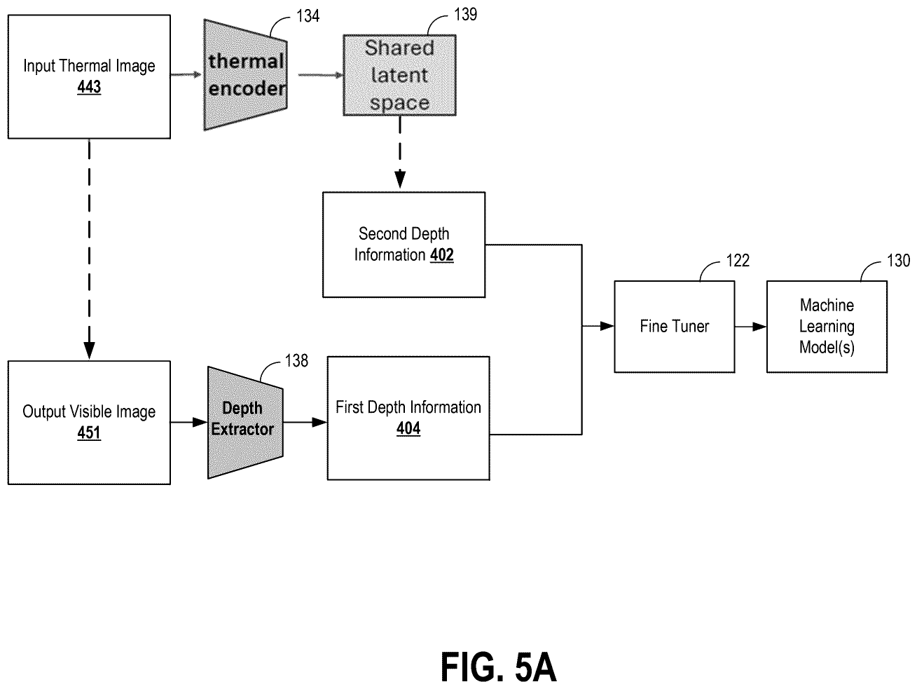

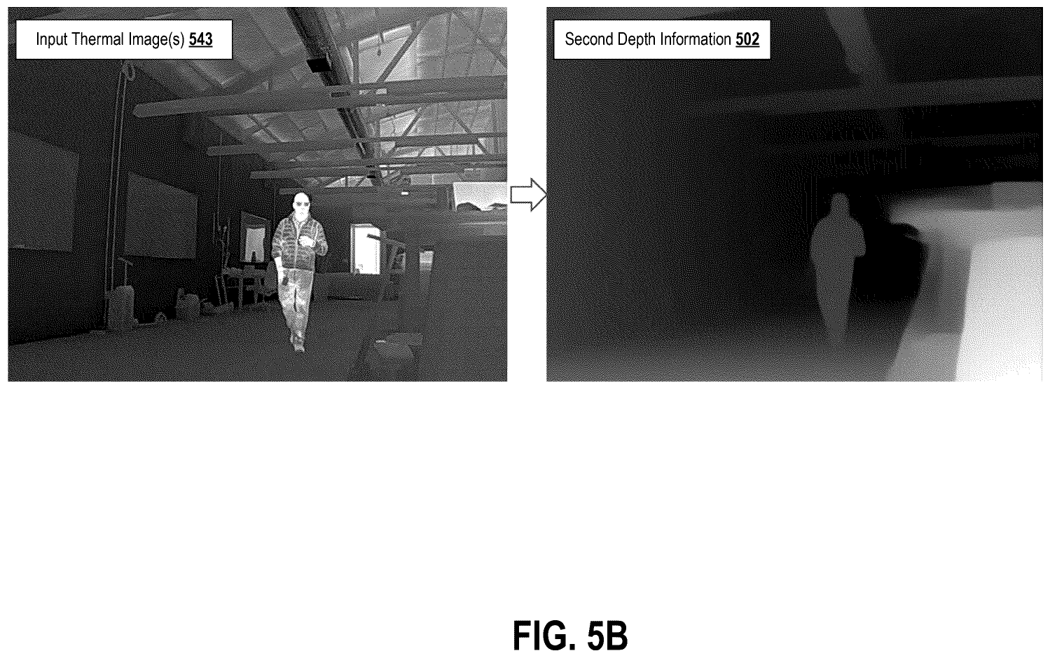

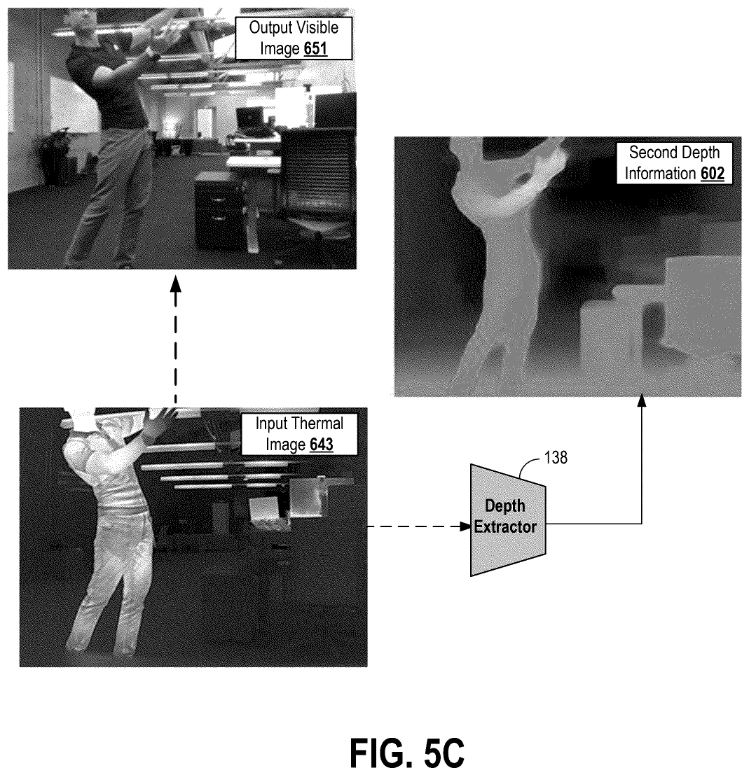

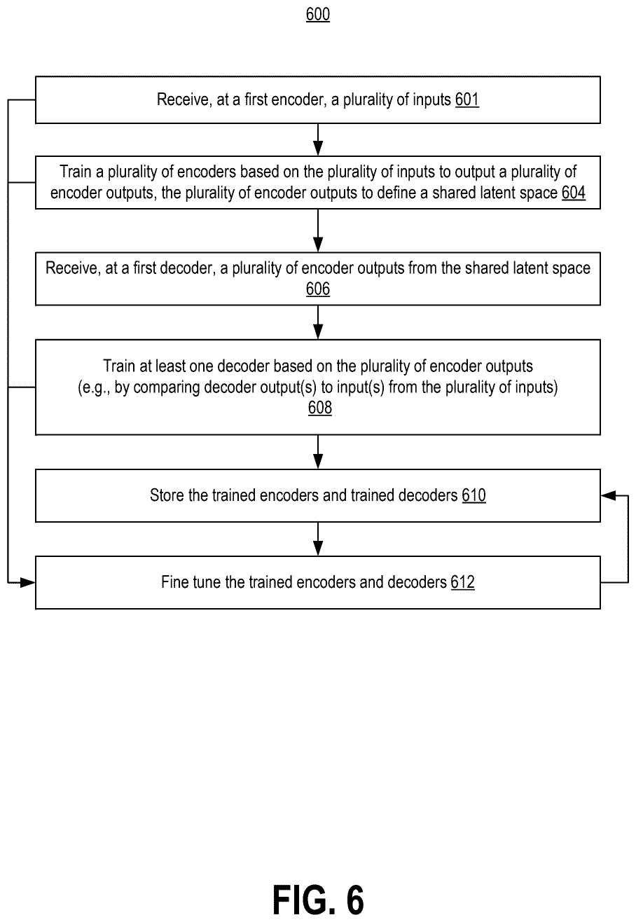

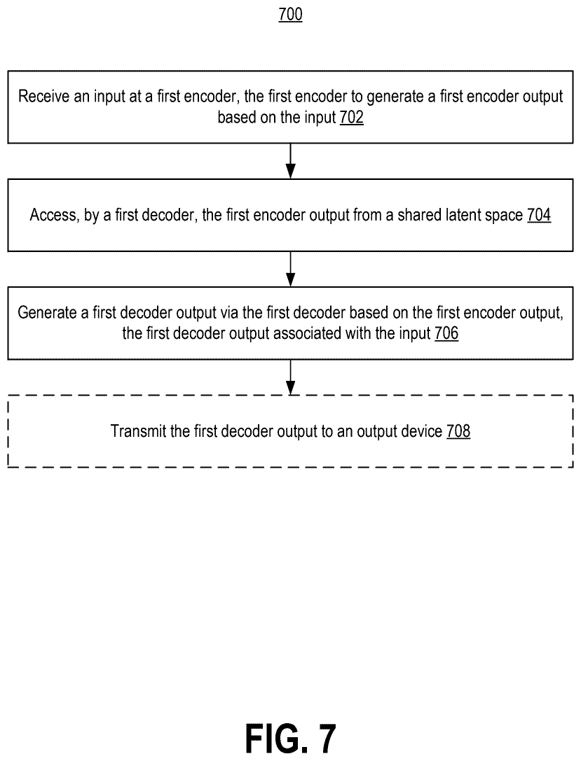

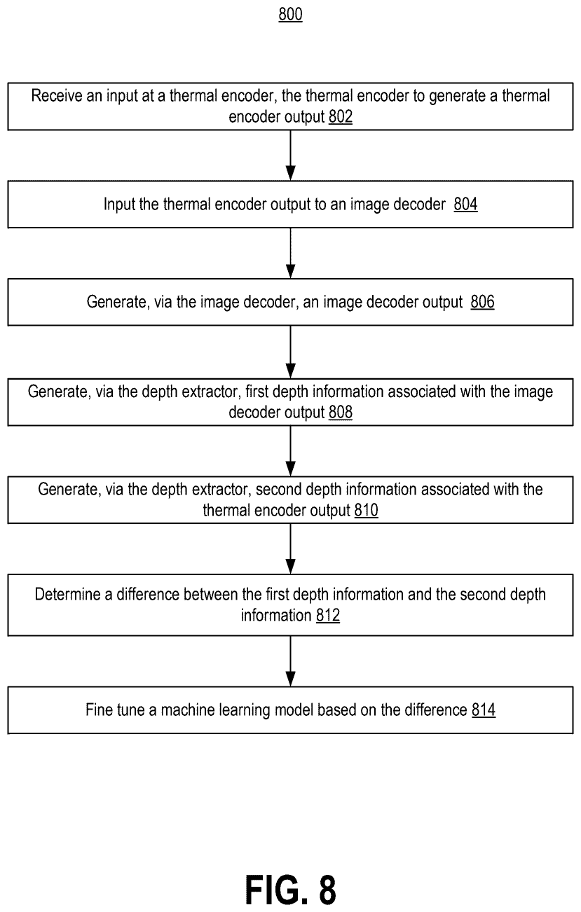

In some embodiments, the image encoder 132, the thermal encoder 134, and the text encoder 136 are trained based on a plurality of input files from each of the thermal camera 142, the visible light camera 140, and/or the I/O devices 144, respectively, as described in detail in connection with at least FIGS. 2 and 6. The image decoder 133, the thermal decoder 135, and/or the text decoder 137 can be configured to receive encoder outputs from at least one of the image encoder 132, the thermal encoder 134, and/or the text encoder 136 to generate decoder output, as described in detail in connection with at least FIGS. 3 and 7. The fine tuner 122 can be configured to fine tune or otherwise adjust the image decoder 133, the thermal decoder 135, and/or the text decoder 137, as described in detail in connection with at least FIG. 4. The depth extractor 138 can be configured to output depth information associated with input from at least one of the image encoder 132, the image decoder 133, the thermal encoder 134, the thermal decoder 135, the text encoder 136, and/or the text decoder 137, as described in connection with at least FIGS. 5A-5C and 8.

Referring now to FIG. 6, FIG. 6 depicts a flowchart of an example method 600 of training a plurality of encoders and at least one decoder. For example, the method 600 can be implemented to train the image encoder 132, the thermal encoder 134, and/or the text encoder 136 and at least one of the image decoder 133, the thermal decoder 135, or the text decoder 137 of the ML model 130 of FIGS. 1A and 2. For illustrative purposes, the method 600 of FIG. 6 is described in connection with FIG. 2.

At block 601, a plurality of inputs is received at a first encoder. As shown in FIG. 2, input visible images 141 can be received at the image encoder 132. In some embodiments, the input visible images 141 are captured by a visible light camera (e.g., the visible light camera 140). Additionally or alternatively, input text phrases 145 can be received at the text encoder 136, input thermal images 143 can be received at the thermal encoder 134, etc. In some embodiments, the input text phrases 145 are captured by an I/O device (e.g., the I/O device 144), the input thermal images 143 are captured by a thermal camera (e.g., the thermal camera 142). In some embodiments, inputs of the plurality of inputs are associated with one another. For example, the thermal camera 142 and the visible camera 140 may be aimed or pointed in a same direction or at a same scene such that the input thermal images 143 include objects, people, landscapes, or other data that corresponds to or matches objects, people, landscapes, or other data in the input visible images 141. Further, the input text phrases 145 can include words, symbols, characters, etc., that describe objects, people, landscapes, or other data included in at least one of the input visible images 141 or the input thermal images 143.

At block 604, a plurality of encoders is trained based on the plurality of inputs to output a plurality of encoder outputs, the plurality of encoder outputs to define a shared latent space. Turning to FIG. 2, the image encoder 132, the thermal encoder 134, and the text encoder 136 are configured to be trained based on the input visible images 141, the input thermal images 143, and the input text phrases 145, respectively. In turn, the image encoder 132 can be configured to output image encoder output, the thermal encoder 134 can be configured to output thermal encoder output, and the text encoder 136 can be configured to output text encoder output. In some embodiments, the image encoder output is one or more encoded visible images generated based on the input visible images 141, the thermal encoder output is one or more encoded thermal images generated based on the input thermal images 143, and the text encoder output is one or more encoded text phrases generated based on the input text phrases 145. The image encoder output, the thermal encoder output, and the text encoder output can define (e.g., collectively define) a shared latent space 139. As such, each of the image encoder 132, the text encoder 136, and the thermal encoder 134 can be trained to collectively define the shared latent space 139.

At block 606, a plurality of encoder outputs is received by a first decoder from the shared latent space. For example, at least one of the image encoder output or the thermal encoder output are received by the text decoder 137 from the shared latent space 139. Additionally or alternatively, at least one of the thermal encoder output or the text encoder output are received by the image decoder 133 from the shared latent space 139, at least one of the text encoder output or the image encoder output are received by the thermal decoder 135 from the shared latent space 139. The image decoder 133 can be configured to output an output visible image 151 based on the plurality of encoder outputs from the shared latent space 139. Additionally or alternatively, the thermal decoder 135 can be configured to output an output thermal image 153 based on the plurality of encoder outputs from the shared latent space 139 and the text decoder 137 can be configured to output an output text phrase 152 based on the plurality of encoder outputs from the shared latent space 139.

At block 608, at least one decoder is trained based on the plurality of encoder outputs. For example, the at least one decoder can be trained by comparing decoder outputs to inputs from the plurality of inputs. As previously mentioned, the plurality of inputs may correspond to one another (e.g., based on a set up of the visible light camera 140 and the thermal camera 142 capturing a same scene). Accordingly, the plurality of encoder outputs may correspond to one another and the outputs (e.g., the output visible image 151, the output text phrase 152, and the output thermal image 153) may correspond to one another. Put differently, the plurality of inputs may be a controlled data set that, once encoded and decoded, corresponds to an expected data set of outputs. A difference between a first one of the input visible images 141 and the output visible image 151 may indicate that the image decoder 133 needs to be trained or retrained to output a visible image that better matches the first one of the visible images 141. Thus, at least one of the image decoder 133, the text decoder 137, or the thermal decoder 135 can be trained or retrained based on the plurality of encoder outputs in the shared latent space 139.

At block 610, the trained encoders and trained decoders are stored. For example, the trained image encoder 132, the trained text encoder 136, the trained thermal encoder 134, the trained image decoder 133, the trained text decoder 137, and the trained thermal decoder 135 can be stored in the ML model 130 and/or the memory 120 (see FIGS. 1A and 1B).

At block 612, the trained encoders and trained decoders are fine tuned. For example, at least one of the trained image encoder 132, the trained text encoder 136, the trained thermal encoder 134, the trained image decoder 133, the trained text decoder 137, and the trained thermal decoder 135 can be fine tuned by comparing the inputs to the outputs, the encoder outputs to the outputs, etc.

Referring now to FIG. 7, FIG. 7 depicts a flowchart of an example method 700 associated with an inference phase of the ML model 130, according to an embodiment. For example, the method 700 can be associated with an inference phase of the image encoder 132, the thermal encoder 134, the text encoder 136, the image decoder 133, the thermal decoder 135, and/or the text decoder 137 of the ML model 130. FIG. 3 is a block diagram illustrating an example inference phase of the text encoder 136 and the thermal decoder 135. For illustrative purposes, the method 700 of FIG. 7 is described in connection with FIG. 3.

At block 702, an input is received at a first encoder, the first encoder to generate a first encoder output based on the input. As shown in FIG. 3, an input text phrase 245 is received at the text encoder 136 (e.g., the text encoder 136 trained based on the shared latent space 139). The text encoder 136 is configured to output an encoded text phrase to the shared latent space 139.

At block 704, the first encoder output is accessed by a first decoder from the shared latent space 139. Turning to FIG. 3, the encoded text phrase can be accessed by the thermal decoder 135 from the shared latent space 139.

At block 706, a first decoder output is generated via the first decoder based on the first encoder output, the first decoder output being associated with the input. As shown in FIG. 3, the output thermal image 253 is generated via the thermal decoder 135 based on the encoded text phrase. Further, the output thermal image 253 can be associated with the input text phrase 245. For example, the output thermal image 253 can illustrate, depict, or include objects, people, landscapes, or other data that is described by words, symbols, characters, etc., included in the input text phrase 245.

At block 708, the first decoder output is transmitted to an output device. For example, the output thermal image 253 can be transmitted to an output device (e.g., a smartphone, desktop, etc.) for display thereof.

In some embodiments, the method 700 can be associated with an inference phase of the text encoder 136 and the image decoder 133. For example, the image decoder 133 can be configured to generate an output visible image associated with the input text phrase 245 by accessing the encoded text phrase in the shared latent space 139. In some embodiments, the method 700 can be associated with an inference phase of the image encoder 132 and the thermal decoder 135. For example, the image encoder 132 can be configured to receive an input visible image and output an encoded visible image to the shared latent space 139. In turn, the thermal decoder 135 can be configured to generate an output thermal image associated with the input visible image by accessing the encoded visible image in the shared latent space 139. In some embodiments, the method 700 can be associated with an inference phase of the image encoder 132 and the text decoder 137. For example, the image encoder 132 can be configured to receive an input visible image and output an encoded visible image to the shared latent space 139. In turn, the text decoder 137 can be configured to generate an output text phrase associated with the input visible image by accessing the encoded visible image in the shared latent space 139. In some embodiments, the method 700 can be associated with an inference phase of the thermal encoder 134 and the image decoder 133. For example, the thermal encoder 134 can be configured to receive an input thermal image and output an encoded thermal image to the shared latent space 139. In turn, the image decoder 133 can be configured to generate the output visible image associated with the input thermal image by accessing the encoded thermal image from the shared latent space 139. In some embodiments, the method 700 can be associated with an inference phase of the thermal encoder 134 and the text decoder 137. For example, the thermal encoder 134 can be configured to receive an input thermal image and output an encoded thermal image to the shared latent space 139. In turn, the text decoder 137 can be configured to generate an output text phrase associated with the input thermal image by accessing the encoded thermal image from the shared latent space 139.

FIG. 4 is a block diagram illustrating an example fine tuning process 401 of the ML model 130, according to an embodiment. In particular, the fine tuning process 401 illustrated that the fine tuner 122 can be configured to fine tune or otherwise adjust the image decoder 133 and/or the thermal decoder 135. In some embodiments, the fine tuner 122 can be configured to fine tune the text decoder 137.

In some embodiments, the fine tuning process 401 can occur after a training process of the ML model 130 has completed. For example, the fine tuning process 401 can occur during an inference phase of the ML model 130. In the example of FIG. 4, the fine tuning process 401 is implemented during an inference phase associated with the image encoder 132, the thermal encoder 134, the thermal decoder 135 and the image decoder 133. As shown in FIG. 4, the image encoder 132 receives an input visible image 341 an outputs image encoder output 302 (e.g., to the shared latent space 139 (not shown)). The thermal decoder 135 can be configured to receive the image encoder output 302 to output an output thermal image 353. Further, the thermal encoder 134 receives an input thermal image 343 and outputs a thermal encoder output 304 (e.g., to the shared latent space 139 (not shown)). The image decoder 133 can be configured to receive the thermal encoder output 304 and output an output visible image 351. In turn, the fine tuner 122 can compare the output visible image 351 to the input visible image 341 to produce a first comparison. The fine tuner 122 can be configured to fine tune the image decoder 133 based on the first comparison. Similarly, the fine tuner can compare the output thermal image 353 to the input thermal image 343 to produce a second comparison. The fine tuner 122 can be configured to fine tune the thermal decoder 135 based on the second comparison.

In some embodiments, the image decoder 133 can be configured to output an output visible image based on at least one of the thermal encoder output 304 (as described above in connection with FIG. 4), text encoder output, or image encoder output. In turn, the fine tuner 122 can compare the output visible image to the input visible image 341 and fine tune the image decoder 133 based on the comparison. Further, the thermal decoder 135 can be configured to output an output thermal image based on at least one of the image encoder output 302 (as described above in connection with FIG. 4), thermal encoder output, or text encoder output. The fine tuner 122 can compare the output thermal image to the input thermal image 343 and fine tune the thermal decoder 135 based on the comparison. In some embodiments, the text decoder 137 (see FIGS. 1B and 2) accesses at least one of the thermal encoder output 304, the image encoder output 302, or text encoder output to generate an output text phrase. The fine tuner 122 can compare the output text phrase to an input text phrase and fine tune the text decoder 137 based on the comparison.

Referring now to FIG. 8, FIG. 8 depicts a flowchart of an example method 800 associated with an depth estimation process of the ML model 130, according to an embodiment. FIG. 5A is a block diagram illustrating an example depth estimation process of the ML model 130. For illustrative purposes, the method 800 of FIG. 8 is described in connection with FIG. 5A.

At block 802, an input is received at a thermal encoder, the thermal encoder to generate a thermal encoder output. As shown in FIG. 5A, an input thermal image 343 is received at the thermal encoder 134. The thermal encoder 134 can be configured to generate a thermal encoder output an output the thermal encoder output to the shared latent space 139.

At block 804, the thermal encoder output is inputted to an image decoder. For example, the thermal encoder output can be inputted to the image decoder 133 (not shown).

At block 806, the image decoder generates an image decoder output. For example, the image decoder 133 (not shown) generates image decoder output (e.g., an output visible image 451). The output visible image 451 can be associated with the input thermal image 443.

At block 808, a depth extractor generates first depth information associated with the image decoder output. As shown in FIG. 5A, the depth extractor 138 generates first depth information 404 associated with the output visible image 451.

At block 810, the depth extractor generates second depth information associated with the thermal encoder output. As shown in FIG. 5A, the depth extractor 138 generates second depth information 402 associated with the thermal encoder output (e.g., from the shared latent space 139).

At block 812, a difference between the first depth information and the second depth information is determined. For example, the fine tuner 122 can determine a difference between the first depth information 404 and the second depth information 402.

At block 814, a ML model in fine tuned based on the difference. For example, the fine tuner 122 can fine tune the ML model 130 based on the difference. In some embodiments, the fine tuner 122 fine tunes at least one of the thermal encoder 134 or the image decoder 133 (not shown) based on the difference. After the fine tuner 122 fine tunes the image decoder 133, for example, the depth extractor 138 can generate third depth information that is associated with the input thermal image 343, the third depth information being different (e.g., more accurate than) the first depth information 404.

FIG. 5B illustrates an example input thermal image 543 and example second depth information 502 associated with the block diagram of FIG. 5A, according to an embodiment. For example, the thermal encoder 134 can receive the input thermal image 543 and output an encoded thermal image to the shared latent space 139. In turn, the depth extractor 138 can access the encoded thermal image to generate the second depth information 502 associated with the input thermal image 543. The input thermal image 543 can include an object (e.g., a person, a table, etc.). In some embodiments, the second depth information 502 conveys or indicates a distance between the object and a thermal camera capturing the input thermal image 543 by a shading of the object in the second depth information 502. In some embodiments, the input thermal image 543 includes a first object and a second object. The second depth information 502 (or the first depth information) can include a first shading of the first object to indicate a first distance between the first object and the thermal camera and a second shading of the second object to indicate a second distance between the second object and the thermal camera. In some embodiments, the second shading is different from (e.g., darker than or lighter than) the first shading based on the second distance being different from the first distance.

FIG. 5C illustrates an example input thermal image 643, an example output visible image 651, and example second depth information 602 associated with the block diagram of FIG. 5A, according to an embodiment. The depth extractor 138 can generate the second depth information 602 based on the input thermal image 643 (e.g., by accessing an encoded thermal image from the shared latent space 139). The image decoder 133 (not shown) can generate the output visible image 651 by accessing the encoded thermal image (generated by the thermal encoder 134) associated with the input thermal image 643 from the shared latent space 139.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An apparatus, comprising:
an image encoder configured to be trained by a plurality of visible images captured by a visible light camera, the image encoder configured to output image encoder output;
a text encoder configured to be trained by a plurality of text phrases, each text phrase from the plurality of text phrases being associated with an object with each visible image from the plurality of visible images, the text encoder configured to output text encoder output; and
a thermal encoder configured to be trained by a plurality of thermal images captured by a thermal camera, the thermal encoder configured to output thermal encoder output,
the image encoder output, the text encoder output and the thermal encoder output collectively defining a shared latent space.

2. The apparatus of claim 1, further comprising:
an image decoder configured to be trained using the shared latent space, the image decoder configured to output a visible image,
a text decoder configured to be trained by the shared latent space, the text decoder configured to output a text phrase,
a thermal decoder configured to be trained by the shared latent space, the thermal decoder configured to output a thermal image.

3. The apparatus of claim 2, wherein:
the visible image is a first visible image,
the image decoder is configured to be trained using the shared latent space by:
accessing at least one of the text encoder output, the thermal encoder output, or the image encoder output from the shared latent space to output the first visible image;
comparing the first visible image to a second visible image from the plurality of visible images to produce a comparison; and
fine tuning the image decoder based on the comparison.

4. The apparatus of claim 2, wherein:
the text phrase is a first text phrase,
the text decoder is configured to be trained using the shared latent space by:
accessing at least one of the text encoder output, the thermal encoder output, or the image encoder output from the shared latent space to output the first text phrase;
comparing the first text phrase to a second text phrase from the plurality of text phrases to produce a comparison, and
fine turning the text decoder based on the comparison.

5. The apparatus of claim 2, wherein:
the thermal image is a first thermal image,
the thermal decoder is configured to be trained using the shared latent space by:
accessing at least one of the text encoder output, the thermal encoder output, or the image encoder output from the shared latent space to output the first thermal image;
comparing the first thermal image to a second thermal image from the plurality of thermal images to produce a comparison; and
fine tuning the thermal decoder based on the comparison.

6. The apparatus of claim 1, further comprising:
an image decoder configured to be trained by the shared latent space, the image decoder configured to output a visible image,
a text decoder configured to be trained by the shared latent space, the text decoder configured to output a text phrase, and
a thermal decoder configured to be trained by the shared latent space, the thermal decoder configured to output a thermal image,
the image encoder, the text encoder, the thermal encoder, the image decoder, the text decoder and the thermal decoder are included within a machine learning model,
the machine learning model being a transformer-based foundation model.

7. An apparatus, comprising:
a processor; and
a memory coupled to the processor, the memory configured to store:
an image encoder, a text encoder and a thermal encoder each having been trained to collectively define a shared latent space; and
an image decoder, a text decoder and a thermal decoder each having been trained based on the shared latent space,
the image encoder configured to receive an input visible image and output to the shared latent space that is accessed by the text decoder to generate an output text phrase associated with the input visible image or accessed by the thermal decoder to generate an output thermal image associated with the input visible image,
the text encoder configured to receive an input text phrase and output to the shared latent space that is accessed by the image encoder to generate an output visible image associated with the input text phrase or accessed by the thermal decoder to generate an output thermal image associated with the input text phrase,
the thermal encoder configured to receive an input thermal image and output to the shared latent space that is accessed by the image encoder to generate an output visible image associated with the input thermal image or accessed by the text decoder to generate an output text phrase associated with the input thermal image.

8. The apparatus of claim 7, wherein:
the thermal encoder is further configured to receive the input thermal image from a thermal camera and output an encoded thermal image to the shared latent space, and
the image decoder is further configured to generate the output visible image associated with the input thermal image by accessing the encoded thermal image in the shared latent space.

9. The apparatus of claim 7, wherein:
the thermal encoder is further configured to receive the input thermal image from a thermal camera and output an encoded thermal image to the shared latent space, and
the text decoder is further configured to generate the output text phrase associated with the input thermal image by accessing the encoded thermal image in the shared latent space.

10. The apparatus of claim 7, wherein:
the text encoder is further configured to receive the input text phrase and output an encoded text phrase to the shared latent space, and
the image decoder is further configured to generate the output visible image associated with the input text phrase by accessing the encoded text phrase in the shared latent space.

11. The apparatus of claim 7, wherein:
the text encoder is further configured to receive the input text phrase and output an encoded text phrase to the shared latent space, and
the thermal decoder is further configured to generate the output thermal image associated with the input text phrase by accessing the encoded text phrase in the shared latent space.

12. The apparatus of claim 7, wherein:
the image encoder is further configured to receive the input visible image from a visible light camera and output an encoded visible image to the shared latent space, and
the text decoder is further configured to generate the output text phrase associated with the input visible image by accessing the encoded visible image in the shared latent space.

13. The apparatus of claim 7, wherein:
the image encoder is further configured to receive the input visible image from a visible light camera and output an encoded visible image to the shared latent space, and
the thermal decoder is further configured to generate the output thermal image associated with the input visible image by accessing the encoded visible image in the shared latent space.

14. The apparatus of claim 7, wherein:
the memory is further configured to store a depth extractor and a machine learning model,
the depth extractor configured to:
receive image decoder output from the image decoder, the image decoder output including the output visible image associated with the input thermal image;
output first depth information associated with the image decoder output;
receive thermal encoder output from the thermal encoder, the thermal encoder output including at least one encoded thermal image; and
output second depth information associated with the thermal encoder output,
the machine learning model configured to be retrained based on a difference between the first depth information and the second depth information.

15. The apparatus of claim 14, wherein:
the input thermal image includes an object and is captured via a thermal camera, and
the second depth information is a depth image including a shading of the object that indicates a distance between the object and the thermal camera.

16. The apparatus of claim 15, wherein:
the input thermal image includes a first object and a second object,
the shading is a first shading,
the second depth information includes the first shading of the first object to indicate a first distance between the first object and the thermal camera,
a second shading of the second object to indicate a second distance between the second object and the thermal camera,
the second shading different from the first shading based on the second distance being different from the first distance.

17. An apparatus, comprising:
a processor; and
a memory coupled to the processor, the memory storing a machine learning model having a thermal encoder, an image encoder, a thermal decoder and an image decoder, the memory further storing a depth extractor,
the thermal encoder configured to receive an input thermal image and output an encoded thermal image to a shared latent space,
the image decoder configured to generate an output visible image associated with the input thermal image based on the shared latent space,
the depth extractor configured to receive the output visible image from the image decoder and to output first depth information associated with the input thermal image,
the machine learning model configured to be retrained based on difference between the first depth information and second depth information associated with the encoded thermal image.

18. The apparatus of claim 17, wherein the machine learning model is further configured to be retrained by retraining at least one of the thermal encoder or the image decoder based on the difference.

19. The apparatus of claim 17, wherein the depth extractor is further configured to generate third depth information that is associated with the input thermal image and that is different from the first depth information.

20. The apparatus of claim 17, wherein:
the machine learning model further includes a text encoder and a text decoder,
the text encoder configured to receive an input text phrase and output to the shared latent space that is accessed by the image encoder to generate an output visible image associated with the input text phrase or accessed by the thermal decoder to generate an output thermal image associated with the input text phrase.
